(19) United States
(12) Patent Application Publication
(10) Pub. No.: US 2004/0016323 A1
(43) Pub. Date: Jan. 29, 2004

(54) Wrench

(76) Inventors: Richard B. Wright, Akron, OH (US); Kenneth R. Milligan, Akron, OH (US)

Correspondence Address: D. PETER HOCHBERG CO. L.P.A., 1940 EAST 6TH STREET, CLEVELAND, OH, 44114, US

(21) Appl. No.: 10/202,157

(22) Filed: Jul. 24, 2002

(51) Int. Cl. B25B 13/02

(52) U.S. Cl. 81/119

(57) ABSTRACT

Open wrenches retain fasteners fully seated in the jaws of the wrench. The jaws have fastener-engaging surfaces with substantially planar and parallel sections that extend past the front side corners of the fastener when it is fully seated in the wrench, and serrated diverging sections extending outwardly and rearwardly from these planar sections. The serrated diverging section may be arcuate or a slightly inclined. Both types of diverging section are designed to reduce slipping, and are connected to rear corners of the fastener-engaging cavity that are designed and positioned to avoid contact with the rear side corners of the fastener. Arcuate rear side corners of the wrench cavity avoid contact with the rear side corners of the fastener, and avoids stress concentration points. The throat that connects the corners has two gentle curves or flat surfaces leading to a central arc. This modified “U” design provide more metal in the throat of the wrench, which stiffens the jaws.

### BACKGROUND

Wrenches with open-ended or open-sided fastener-engaging cavities (referred to herein collectively as “open” wrenches), are designed to engage hexagonal fasteners by being moved in the direction of the axis of the fastener, or at right angles to the axis. They are not only more convenient to engage, they are able to engage fasteners that other styles of wrenches, such as socket or box wrenches, are unable to engage because the ends of the fasteners are not accessible. Engaging the fastener on a tubing fitting is a good example.

Unfortunately, open end wrenches are not nearly as strong as box or socket wrenches, but it is desirable to tighten or loosen the fasteners to the same level as socket and box wrenches, if the fasteners are to do their job. Open wrenches, whether with fixed jaws as in the design customarily referred to as “open-end” or with adjustable jaws such as Crescent®, Stillson or pipe wrenches, must meet various design criteria. They must be strong and stiff enough to transmit torque to nuts, bolts and other fasteners with polygonal heads. Both stiffness and strength are important because wrenches can fail either by the jaw breaking, or by the jaw spreading apart in such a manner that the fastener turns, or the fastener turns part way and then the corners of the fastener yield, allowing the fastener to turn the rest of the way.

Open wrenches have a tendency to spread under load. This lets the fastener rotate in the wrench, which tends to allow the wrench to move relative to the fastener, damaging the corners of the fastener. Under heavy loads, the wrench may move relative to the fastener in such a way that the fastener rotates toward the outside of the wrench opening, which is a much weaker position of engagement, and can result in damage to the wrench or the fastener. Thus, another important feature of open end wrench design is to keep the fastener fully seated in the wrench opening, preferably touching the base of the wrench opening or throat, so as to minimize the bending moments on the jaws. It is for this reason that it is undesirable to have the fastener “walk” out of the wrench opening as a result of relative rotation of the wrench and fastener. This can occur even if the user has properly positioned the wrench all the way on to the fastener. Shifting may occur under load as a result of the deflections and deformations occurring under load.

FIGS. 1 and 4 illustrate a standard wrench 10 with substantially planar sides or jaws 13, 14 joined to a generally “U” shaped back or throat 18. The wrench is shown in the conventional tightening position, turning or torquing the fastener clockwise. FIGS. 2, 3, 5, 6 and 8 and the solid line view of the fastener in FIG. 7 show wrenches and fasteners in similar positions. The phantom or dotted line view of the fastener in FIG. 7 illustrates the “neutral” or unloaded position. In this position the sides of the fastener are generally parallel to the jaws of the wrench, which do not apply torque to the fastener in either direction.

The contact points and forces between the jaws and fastener are interchanged to transmit torque in the opposite direction. Because of this, wrench 10 is symmetrical about the center line CL of fastener-engaging opening 16, as are almost all open-end wrenches.

This wrench is susceptible to the problems discussed above. The curved back avoids stress concentration points, but it reduces the amount of metal in the head 11 of the wrench. This weakens the wrench and reduces its stiffness. As the load is increased, the jaws of the wrench will tend to spread apart elastically and the corners of the fastener will tend to deform both elastically and plastically. To be in static equilibrium, the wrench must make contact with at least two points on the fastener as this is occurring. Since the shapes are changing, there must be relative motion between the wrench and the fastener. This will require rotation about either the left front corner or point 24 of the fastener or the right rear corner or point 27, as shown in FIG. 4, on a basis of chance. If rotation happens to occur about point 24, the rear corner or point 22 of the fastener moves away from contact with the wrench, point 27 moves toward the end of the wrench, force B moves further out in the opening, and the location of force A remains the same. In that case, the magnitude of forces A and B must increase to apply the same amount of torque to the fastener, because the applied torque is equal to the value of force A times distance a plus the magnitude of force B times the distance b. This increase in force causes the jaws to spread further than they would had the rotation occurred about corner 27. If the rotation occurs at corner 27, contact will still be maintained at point 22, and there will be no significant change in the location and magnitudes of forces A and B. In the wrench shown in FIG. 4, either mode of loading occurs by chance. This invention biases the contacts in such a way that rotation is about point 27 rather than about point 24 when the rotation is clockwise and, therefore, the forces are as shown.

FIG. 2 shows another conventional open wrench 30, which differs from the wrench in FIG. 1 by having a V-shaped back or throat 38, with sharp corners 381, 383 where the throat meets the planar sides 331, 341 of the wrench, and another sharp corner 382 at the central axis X of the fastener-engaging cavity 36. The cross-hatched area between the V-shaped back 38 and the phantom outline of the U-shaped back of the wrench in FIG. 1 is additional metal that strengthens the jaws 33, 34 of wrench 30. Unfortunately, corners 381, 382 and 383 are stress concentration points that weaken this wrench.

A variety of open designs have been adopted or proposed in attempts to provide wrenches that come closer to meeting these goals than conventional polygonal wrenches, which have substantially planar sides and sharp corners. Representative examples are provided by U.S. Pat. Nos. 3,242,775 to Hinkle, 5,117,714 to Pagac et al, and 5,381,710 to Baker. All offer advantages, but all of these designs also suffer from disadvantages. Hinkle provides inclined surfaces at both the inner and outer end of his fastener-engaging surfaces. This reduces the tendency to exert pressure on the corners of the fastener, but it reduces the length of the moment arm of the force couple on the fastener, i.e. the product of the forces applied to the fastener times the lengths of the distances from the force vector to the central axis of the fastener. For example, in the conventional U-shaped wrench shown in FIG. 4, the torque applied to fastener 20 is equal to force vector A times moment arm a plus force vector B times moment arm b. This reduction of the length of the moment arm about the axis of the fastener increases the force that must be exerted by the jaws to generate an equivalent amount of torque. The problem gets worse if the fastener “walks” or slips part way out of the fastener. This lengthens the moment arms m and n on jaws 13 and 14, i.e. the distance from the base of throat 18 to the points where force vectors A and B are applied to the fastener. Like many currently available open-end wrenches, Hinkle does not have any way to grip the side of the fastener securely, which makes his design prone to slip, and increase the force couples on the jaws of the wrench. This increases the risk that the jaws will fail, or be deformed enough to allow the fastener to slip and be damaged.

Pagac et al provide serrations on the fastener-engaging jaws of their wrench. But the jaws also have relief regions to prevent the front corners of the fasteners from contacting the jaws. As with the Hinkle design, this shortens the force couple arm and increases the force and torque that must be applied by the wrench to torque the fastener by the same amount. Baker's curved fastener-engaging jaws suffer from similar problems. If the fastener is not fully seated in Pagac's jaws, the same force must be applied at points further out on the jaws, increasing the bending torque on the jaws of the wrench.

### SUMMARY OF THE INVENTION

Open wrenches embodying this invention retain fasteners fully seated in the open fastener-engaging cavity of the wrench. This reduces the forces tending to bend or break the jaws of the wrench, and reduces the risk of slipping off or damaging the fastener. The jaws of the wrench have fastener-engaging surfaces with substantially planar and parallel sections that extend past the front side corners of the fastener when it is fully seated in the cavity. Serrated diverging sections extending outwardly and rearwardly from said planar sections. These serrated diverging sections provide a secure grip on the side of the fastener when the wrench turns about the axis of the fastener. At the same time, the planar section of the opposite jaw, which extends past the opposite front corner of the fastener, provides a force couple with a long moment arm, which reduces the force required.

The serrated diverging section may be arcuate or a slightly inclined. With either design, the position where the diverging section contacts the side of the fastener will depend on the torque required and the clearance between the fastener and the fastener-engaging surface. Both types of diverging section are designed to reduce slipping, and are connected to rear corners of the fastener-engaging cavity that are designed and positioned to avoid contact with the rear side corners of the fastener.

Wrenches embodying this invention are both stronger and stiffer than conventional open end wrenches. The rear side corners of the wrench cavity are arcuate. In addition to avoiding contact with the rear side corners of the fastener, this avoids stress concentration points. So does the throat that connects the corners. Two gentle curves or flat surfaces lead to a central arc that limits the rearward movement of the fastener in the wrench cavity, but permits the rear end of the fastener to move laterally, which minimizes damage to this corner. The smooth curve from the arcuate corners to the gentle arcs or flat surfaces to the central arc minimizes stress concentration, and the gentle arcs or flat surfaces of this modified “U” design provide more metal in the throat of the wrench, which stiffens the jaws. This reduces deflection of the jaws under load.

Other advantages of this invention will be apparent from the following description.

### DRAWINGS

FIG. 1 illustrates a conventional open-end wrench with a rounded back or throat.

FIG. 2 illustrates a conventional open-end wrench with a V-shaped back or throat.

FIG. 3 illustrates an open wrench embodying this invention.

FIGS. 4 and 5 are enlarged views, respectively, of the conventional wrench in FIG. 1 and the wrench in FIG. 3, which embodies this invention.

FIG. 6 is an enlarged, fragmentary view of one diverging section of a jaw of the wrench shown in FIGS. 3 and 5.

FIG. 7 depicts another open wrench embodying this invention.

FIG. 8 is an enlarged fragmentary view of one diverging section of a jaw of the wrench shown in FIG. 7.

### DETAILED DESCRIPTION

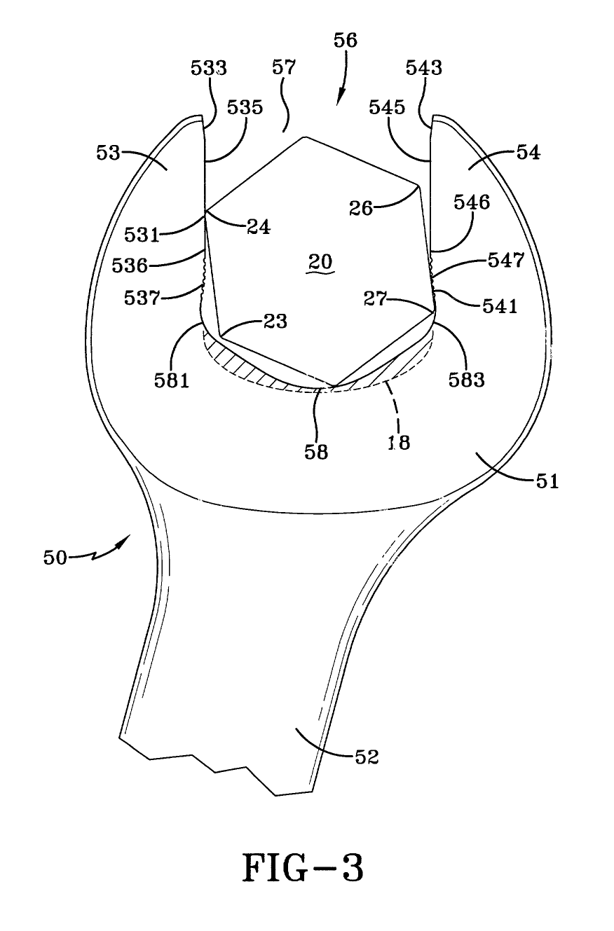

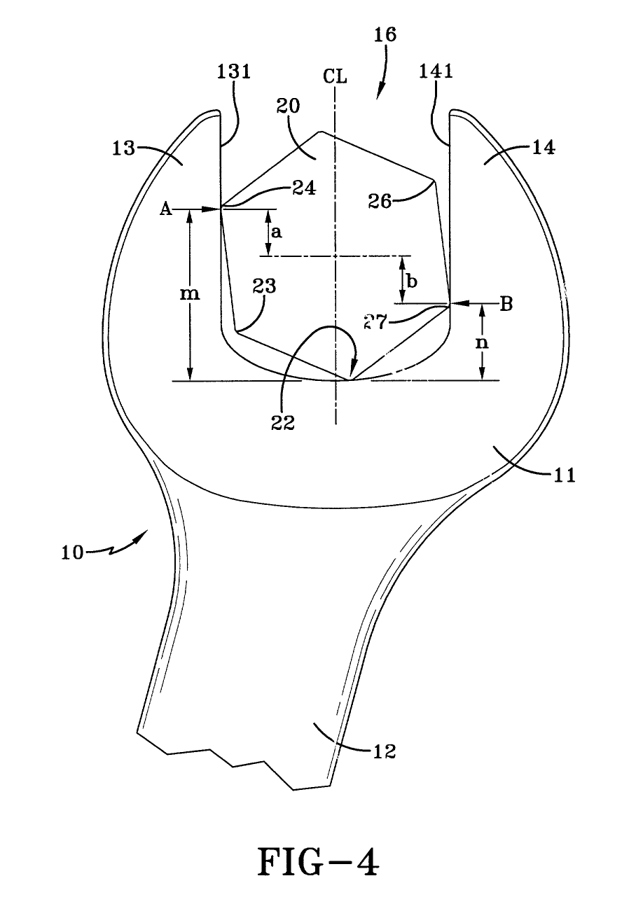

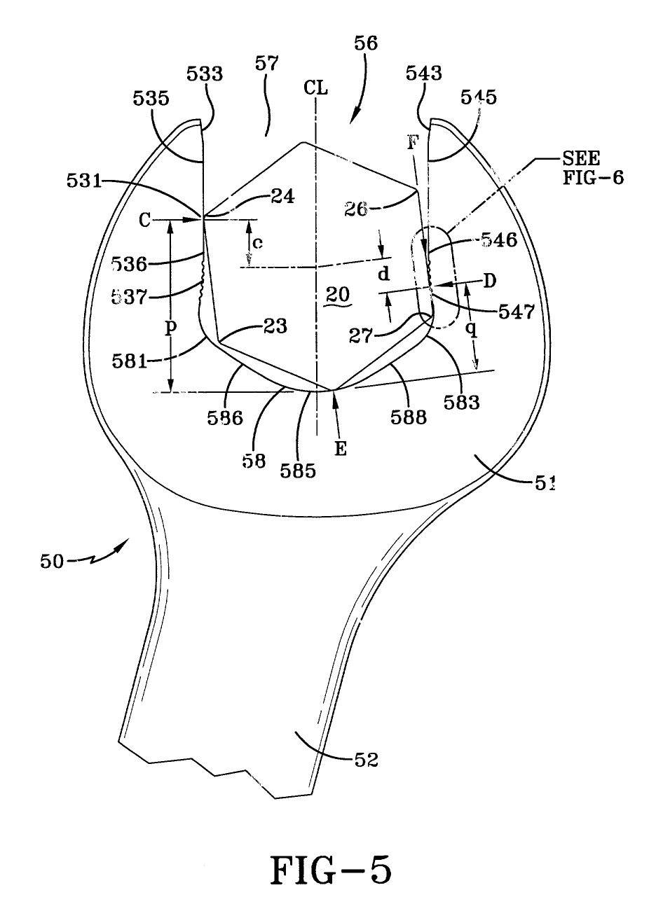

FIG. 3 and 5 illustrate an open-end wrench 50 embodying this invention. This wrench has a head 51 and an attached handle 52 for turning the head. Head 51 has two fixed jaws 53, 54, connected by a throat 58. Jaws 53 and 54 and throat 58 define an open-ended fastener-engaging cavity 56, i.e. a cavity with an opening 57 at the end of the cavity so that the cavity can be slipped onto a nut 20 or similar fastener of the same basic size as the cavity. Terms such as “fastener,” “fastener-engaging cavity” “fastener-engaging surface” and the like are used herein for simplicity. It should be understood that these terms are meant to cover nuts, bolts, screws with polygonal heads and other fasteners designed to be gripped and/or manipulated by tools with polygonal openings, and tools for gripping and manipulating such fasteners. Similarly, as mentioned above, terms such as “open” “open-end” and the like should be understood to cover both wrenches with fixed jaws, as shown in the Figures, and wrenches with adjustable jaws such as Crescent® wrenches, Stillson wrenches and pipe wrenches. Each of the jaws 53, 54 has a fastener-engaging surface 531, 541 with several distinct sections designed to improve the performance of the wrench. At the front end of cavity 56, adjacent to opening 57, each fastener-engaging surface has a chamfer 533, 543 that facilitates engagement of the fastener. These chamfers lead to two substantially planar, substantially parallel sections 535, 545 that define the basic size of the wrench.

When fastener 20 is fully inserted into the fastener-engaging cavity 56, i.e. when the rear corner 22 of the fastener is touching or near throat 58, the front ends of planar sections 535, 545 extend past the front side corners 24, 26 of the fastener. The rear ends of these sections extend to points 536, 546 between the front side corners and the rear side corners 23, 27 of the fastener. At these points the parallel planar sections 535, 545 connect to two serrated, diverging sections 537, 547 that extend to the rounded rear corners 581, 583 of the fastener-engaging cavity. Points 536, 546 are preferably near the center of the sides 231, 261 of the fastener when the wrench is in the “neutral” position.

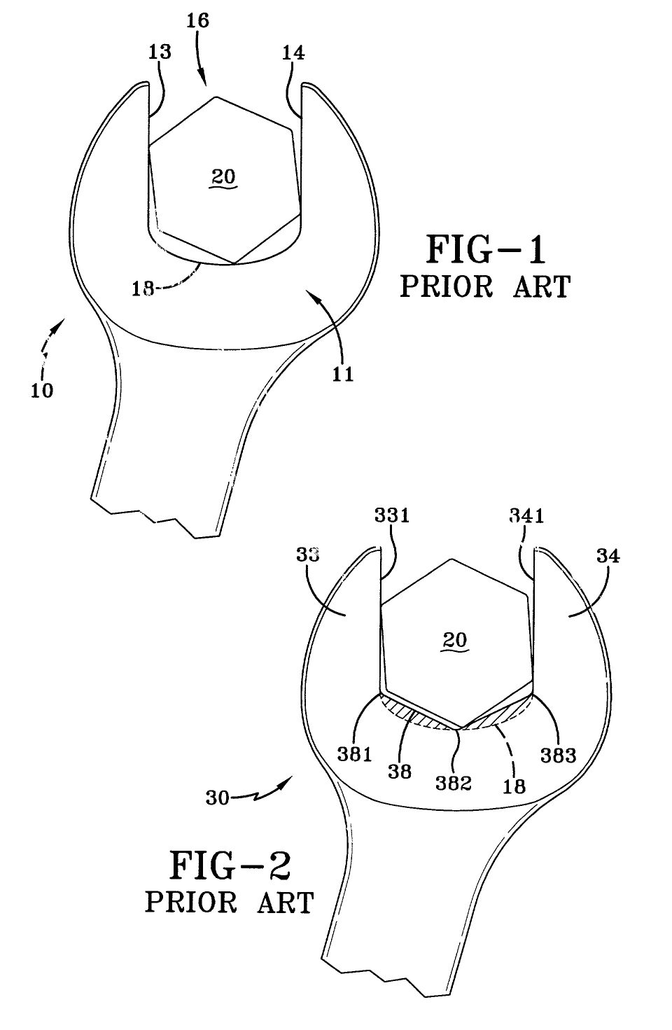

Fasteners, and fixed-jaw wrenches, are produced to established standards, designed to ensure that the largest fastener that meets specifications for a given nominal size will fit into the smallest wrench of that size. Conversely, the smallest fastener of any nominal size must be gripped and turned by the largest wrench for that size. There will always be some clearance between the fastener and wrench. The clearance will be minimal with a large fastener and small wrench, and larger with a small fastener and large wrench. This clearance dictates the “free swing” for any given fastener and wrench, i.e. the amount of free rotation of the wrench from the to the loaded or tightening position shown in FIGS. 1-5 to the opposite or loosening position.

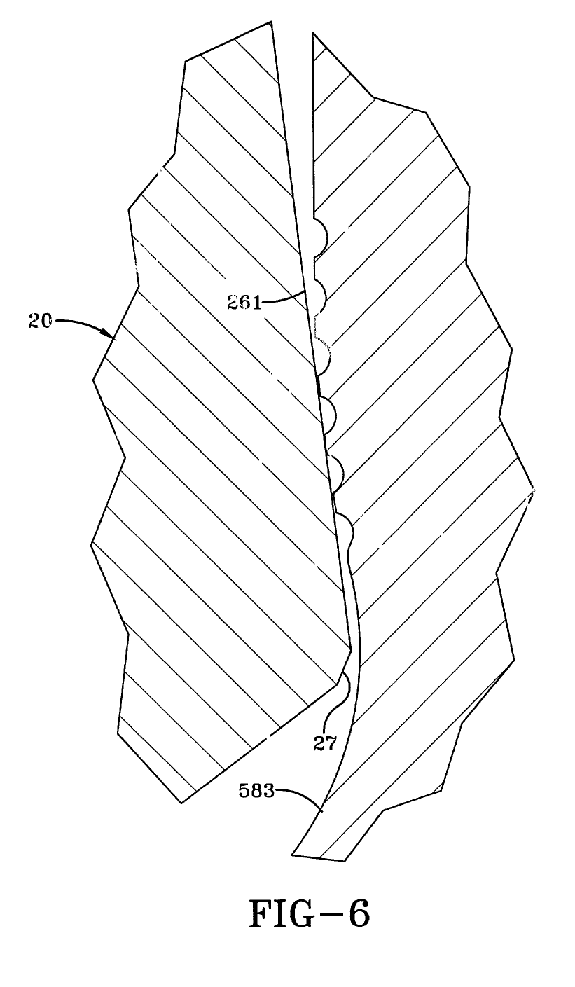

Diverging sections 537 and 547 are designed to optimize the relationship of the jaws and fastener relative to each other in the loaded position. As shown in FIG. 6, sections 537 and 547 (section 537 is not shown in these figures but has a complimentary shape) diverge from planar sections 535 and 545 in gentle arcs, preferably with a radius of about (0.9±0.2) times the width of the fastener engaging cavity 56, i.e. the distance between parallel fastener-engaging surfaces 535 and 545. For example, in one open end wrench shaped as illustrated in FIG. 5, designed for 9/16″ fasteners, the width of fastener engaging cavity 56 is about 0.566″ and diverging sections 537, 547 have a radius of about 0.50″. These dimensions, and other dimensions of wrench 50, are adjusted proportionally for wrenches of different.

The edges 549 at the tops of serrations 548 (or other irregularities such as grooves, knurls or other projections or protuberances with relatively sharp edges) on section 547 and the rear part of section 545 grip the side 261 of the fastener, and help to prevent it from slipping. If the fastener fits snugly in the wrench, or less torque is required, contact may be somewhat farther forward, perhaps on the point 546 where diverging section 547 meets planar section 545. If the fit between the wrench and fastener is looser, or more torque is needed, contact may be further back, as shown in FIG. 6. The serrations are preferably semicircular groves, as shown in these figures, to avoid stress concentration points at the bottoms of grooves, and the diverging sections 547 are designed to contact the fastener on surface 261, not on corner 27.

As mentioned above, fastener-engaging surfaces 531, 541 are designed to extend past the front side corners 24, 26 of the fastener when it is fully seated in fastener-engaging cavity 56. Thus, when the fastener is torqued as shown in FIG. 2, planar section 535 is in contact with the left front corner 24 of the fastener. This is true even if the fastener is only partially seated in cavity 56, as long as the left front corner 24 of the fastener is on planar section 535, i.e. behind the chamfer 533 at the front of the jaw 53 in FIG. 5. This increases the lever arm c of the force on jaw 53 (in comparison to wrenches such as those disclose in the Hinkle, Pajac and Baker mentioned above), and reduces the amount of force that must be applied (vector C). In turn, this reduces the force that must be applied by jaw 53, which reduces the bending torque on the jaw (vector C times moment arm p). The serrations on diverging surfaces 537 and 547 contribute by keeping the fastener fully seated in the fastener-engaging cavity 56, which shortens moment arm p.

Throat 58 has a modified “U” design that reduces stress concentration and provides more metal in the throat. This stiffens the jaws so that they do not deflect as much under load, which is the means by which open-end wrenches frequently cease to operate. The center of the throat 58 is a gentle concave arc 585 with a radius of about 0.30 to about 0.60 (preferably about 0.45) times the width of the fastener-engaging cavity 56. Arcuate rear corners 581 and 583 are designed and positioned to avoid contact with the left rear and right rear corners 23, 27 of fastener 20. Thus, damage to the corners of the fastener is reduced.

Arc 585 is connected to corners 581 and 583 by two flat surfaces or gentle arcs 586 and 588, with radii of no less than twice the width of fastener engaging cavity 56. In the 9/16″ wrench described above, these arcs may have a radius of about 1.5″, or almost three times the width of the fastener engaging cavity 56.

As may be seen in FIG. 3, the cross-hatched area between the modified U-shaped back 58 and the phantom outline of the U-shaped back 18 of wrench 10 adds metal to the throat 58 of the wrench, thereby stiffening and strengthening it. Also, since there is a series of gradual linked curves from the left fastener-engaging surface 531 through the left rear corner 581, throat 58 and right rear corner 583 to the right fastener-engaging surface 541, there are no stress concentration points where failures would be more likely to occur. The modified U-shaped back or throat of this invention does not add as much metal as a conventional V-shaped wrench. However, avoiding stress concentration points produces a stronger wrench.

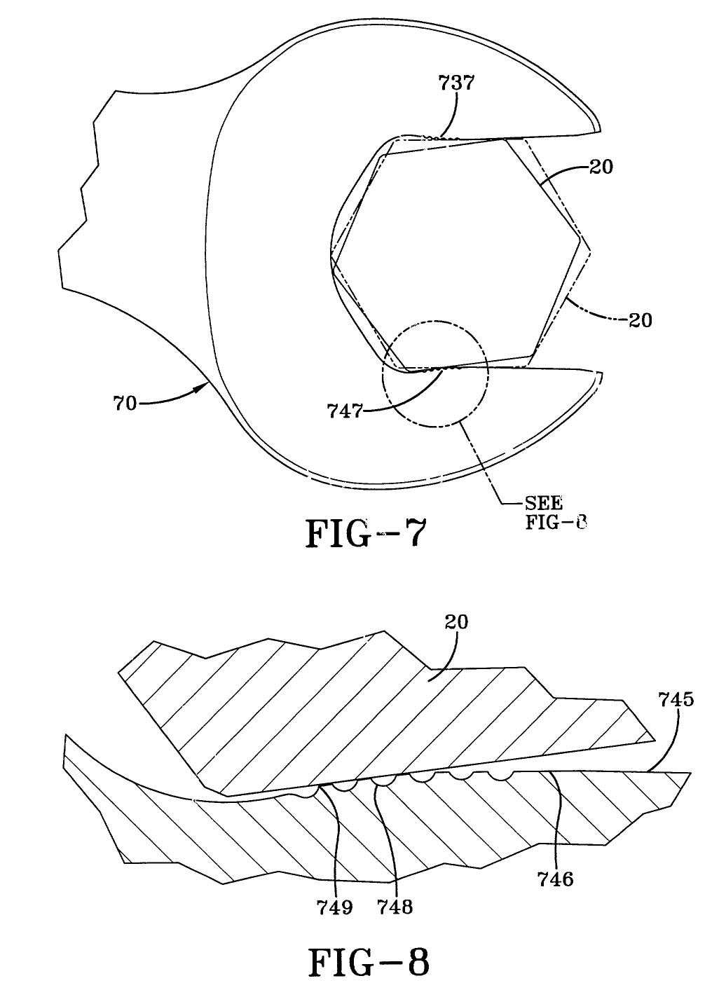

FIG. 7 illustrate another wrench 70 embodying this invention, with slightly different diverging sections 737, 747. In this embodiment, the tops of the serrations in the diverging sections, one of which 747 is shown in FIG. 8, lie substantially in a common plane that diverges from the planar section 745 in front of it by about 3 to 12°, preferably about 6°. When the wrenches begins to torque the fastener counterclockwise, the wrench rotates so that the tip 749 of the serration closest to parallel section 345 contacts the right side 261 of the fastener. As the torque and deformation of the wrench and/or fastener increases, the right side 261 of the fastener will lie across more of the tips 749 of the serrations on diverging section 747, as shown in FIG. 8. If the torque and deformation increase still further, the side 261 of the fastener may come to rest on the tip 749 of the last serration on diverging section 747.

Those skilled in the art will readily appreciate distinct advantages provided by the wrenches described above. Foremost of these is the ability to transmit as much as 50% more torque to the fastener as a result of more consistent and reliable positioning of the wrench on the fastener under load and because of the stiffening of the jaws. The chance of the wrench slipping off the fastener under heavy loads is reduced. Although some rounding of the corners is inevitable if a heavy load is applied to the fastener, the amount of damage to the fastener is reduced and the amount of distortion of the shape which might interfere with future wrenching is reduced.

Of course, while the invention has been described in detail, with particular emphasis on preferred embodiments, those skilled in the art should also appreciate that many variations and modifications to and variations of the embodiments described herein within the spirit and scope of this invention, which is defined by the following claims

We claim:

1. A symmetrical open end wrench with a fastener-engaging opening having an axis of symmetry and fastener engaging surfaces comprising first substantially planar sections extending parallel to said axis of symmetry, outwardly diverging sections between said first substantially planar sections and rear side corners of said opening, and irregularities that grip said fastener.

2. A symmetrical open end wrench according to claim 1 wherein said diverging sections of said fastener engaging surfaces comprise arcs that curve outwardly from said first substantially planar sections.

3. A symmetrical open end wrench according to claim 1 wherein said diverging sections of said fastener engaging surfaces comprise second planar sections that form obtuse angles with said first planar sections.

4. A symmetrical open end wrench according to claim 1, further comprising a throat, wherein said diverging sections of said fastener engaging surfaces are connected to said throat by arcuate corners.

5. A symmetrical open end wrench according to claim 4 wherein said throat further comprises linking sections connecting said central portions to said arcuate corners.

6. A symmetrical open end wrench according to claim 1 wherein said irregularities comprise grooves, serrations, knurls or other projections or protuberances with relatively sharp edges.

7. A symmetrical open end wrench according to claim 6 wherein said irregularities are located on said diverging sections and on the rear portions of said first planar sections.

8. A wrench having:
an opening with an open end;
a throat closing an end of said opening opposite said open end; and
a plurality of jaws with fastener engaging surfaces that extend from said throat toward said open end, defining sides of said opening and adapted to grip a fastener within said opening, said fastener engaging surfaces comprising:,
first planar sections positioned to extend past the front side corners of a polygonal fastener fully seated within said opening, opposite pairs of said first planar sections being substantially parallel to each other; and
diverging sections extending outwardly from said planar sections, extending from a rear end of said first planar sections toward said throat, and adapted to contact rear portions of said sides of said generally polygonal fastener when said wrench turns about an axis of said fastener.

9. A wrench according to claim 8 wherein said diverging sections of said fastener engaging surfaces comprise arcs that curve outwardly from said first planar sections.

10. A wrench according to claim 9 wherein said arcs have a radius of about 0.7 to about 1.1 times the width of the fastener-engaging opening.

11. A wrench according to claim 9 wherein said arcs have a radius of about 0.9 times the width of the fastener-engaging opening.

12. A wrench according to claim 8 wherein said diverging sections of said fastener engaging surfaces comprise second planar sections that form obtuse angles with said first planar sections.

13. A wrench according to claim 11 wherein said obtuse angles are between about 3° and about 12°.

14. A wrench according to claim 11 wherein said obtuse angles equal about 6°.

15. A wrench according to claim 8 wherein said throat comprises a central portion having a radius between about 0.3 and about 0.6 times the width of the fastener-engaging opening

16. A wrench according to claim 8 wherein said throat comprises a central arc having a radius about 0.45 times the width of the fastener-engaging opening

17. A wrench according to claim 8 wherein said diverging sections of said fastener engaging surfaces are connected to said throat by arcuate corners.

18. A wrench according to claim 17 wherein said throat further comprises linking sections connecting said central arc to said arcuate corners.

19. A wrench according to claim 18 wherein said linking sections have radii of no less than about 2 times the width of the fastener-engaging opening.

20. A wrench according to claim 8 wherein said irregularities are located on said diverging sections and on the rear portions of said first planar sections.

21. A wrench according to claim 8 wherein said irregularities comprise grooves, serrations, knurls or other projections or protuberances with relatively sharp edges.
